(19) United States
(12) Patent Application Publication
(10) Pub. No.: US 2002/0088001 A1
(43) Pub. Date: Jul. 4, 2002

(54) Quote and information system

(76) Inventors: Fred J. Zustak, Poway, CA (US); Matthew S. Chang, San Diego, CA (US); Aditya Krishnan, San Diego, CA (US); Andrew M. Proehl, San Francisco, CA (US); David K. L. Yang, San Jose, CA (US); Peter Rae Shintani, San Diego, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/753,444

(22) Filed: Jan. 3, 2001

(51) Int. Cl. H04N 7/173

(52) U.S. Cl. 725/109; 725/110; 725/133

(57) ABSTRACT

A quote and information system for use within the home. A subscriber utilizes a set-top box as a vehicle for navigating a menu system to solicit quotes from vendors using a service provider as an intermediary. Requests for quotes are anonymously forwarded to appropriate vendors and quotes returned to the subscriber. In other embodiments, the menu system can be used to obtain hierarchical categorized information or to register products in order to receive offers from local vendors relating to those products.

### FIELD OF THE INVENTION

This invention relates generally to the field of television set-top boxes. More particularly, this invention relates to a method and apparatus for a set-top box used as a quote and information system for the home.

### BACKGROUND OF THE INVENTION

Television set-top boxes were initially introduced to provide tuning capabilities for cable and satellite television systems. While these devices still provide that fundamental function, digital set-top boxes now often incorporate powerful computers in the latest generation of set-top boxes. With such computers available, it is now possible to expand the usefulness of the television set-top box beyond that of merely providing tuning functions for cable and satellite systems.

### SUMMARY OF THE INVENTION

The present invention relates generally to a system and method for providing a quote and information system for the home using a set-top box communicating with a service provider. Objects, advantages and features of the invention will become apparent to those skilled in the art upon consideration of the following detailed description of the invention.

In one embodiment of the present invention a quote and information system for use within the home is provided in which a subscriber utilizes a set-top box as a vehicle for navigating a menu system to solicit quotes from vendors using a service provider (MSO—Multiple Service Operator) as an intermediary. Requests for quotes are anonymously forwarded to appropriate vendors and quotes returned to the subscriber. In other embodiments, the system can further be used to obtain hierarchical categorized information or to register products in order to receive offers from local vendors relating to those products.

In accord with one embodiment consistent with the present invention, a television set-top box includes a tuner for receiving signals representing television programming and delivering the signals representing television programming to a display interface. A bar code reader is operatively coupled to a central processor, to receive data from a swipe card passed through the swipe card reader. A program running on the central processor receives the bar code information from the bar code reader.

A method of obtaining quotes consistent with the present invention includes:

at a set-top box, submitting a request for quote (RFQ) to a service provider; at the service provider, resubmitting the RFQ to a plurality of vendors; at the service provider, receiving a plurality of quotes from vendors; and at the service provider, forwarding the quotes to the set-top box for communication to a subscriber.

A method of registering a product consistent with embodiments of the present invention includes: at a set-top box, submitting product registration data to a service provider; at the service provider, entering the product registration data into a database; at the service provider, matching the product registration data to a plurality of vendor registrations submitted by a plurality of vendors; at the service provider, sending the product registration data to a plurality of matching vendors; at the service provider, receiving a plurality of submissions from the plurality of matching vendors; and forwarding the submissions to the set-top box for communication to a subscriber.

A method of obtaining information consistent with embodiments of the present invention includes: at a set-top box, submitting a request for information to a service provider; at the service provider, receiving the request for information and matching the request for information with a plurality of vendor submissions; at the service provider, sending the plurality of vendor submissions to the set-top box for communication to a subscriber.

A television set-top box consistent with embodiments of the invention includes a tuner for receiving signals representing television programming and delivering the signals representing television programming to a display interface. A central processor is provided and a product identification reader is operatively coupled to the central processor to read a product identifier. A program running on the central processor receives information from the product identification reader.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a system block diagram of a system using a set-top box.

FIG. 2 is a functional block diagram of a digital set-top box suitable for use with the present invention.

FIG. 3, made up of FIGS. 3A, 3B and 3C, is a first illustration of an exemplary menu system consistent with an embodiment of the invention. FIG. 4 is a message flow diagram describing a process consistent with the menu system illustrated in FIG. 3.

FIG. 5 is a flow chart depicting an embodiment of the present invention consistent with that of FIG. 3 and FIG. 4.

FIG. 6 is a second illustration of an exemplary menu system consistent with an embodiment of the invention.

FIG. 7 is a message flow diagram describing a process consistent with the menu system illustrated in FIG. 6.

FIG. 8 is a flow chart depicting an embodiment of the present invention consistent with that of FIG. 6 and FIG. 7.

FIG. 9 is a third illustration of an exemplary menu system consistent with an embodiment of the invention.

FIG. 10 is a message flow diagram describing a process consistent with the menu system illustrated in FIG. 9.

FIG. 11 is a flow chart depicting an embodiment of the present invention consistent with that of FIG. 9 and FIG. 10.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

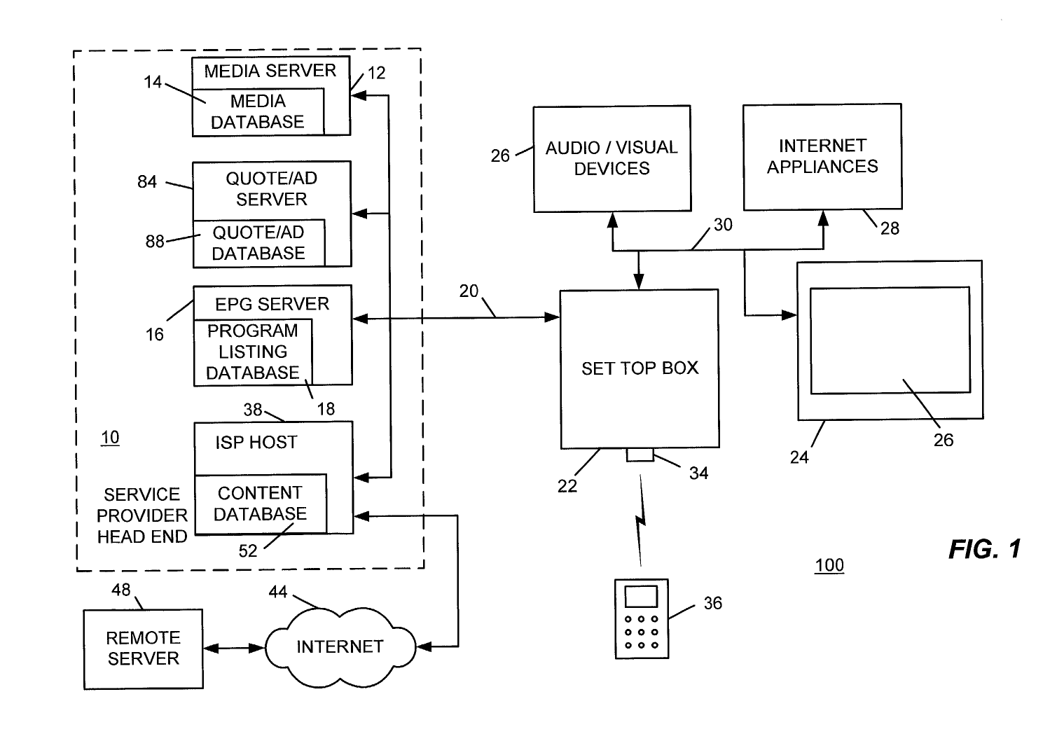

Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet.

The media server 12 and EPG server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, an EPG, etc. The STB 22 may be coupled to the TV 24 and various other audio/visual devices 26 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface—Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 1 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 1 may actually reside in other locations, but from the perspective of the user of STB 22, the service provider 10 serves as a portal to the services shown. Those skilled in the art will appreciate that the illustration of FIG. 1 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Those details can be found in the publicly available CableLabs OpenCable™ specification or in the text “OpenCable Architecture (Fundamentals)” by Michael Adams, Cisco Press, Nov. 1999.

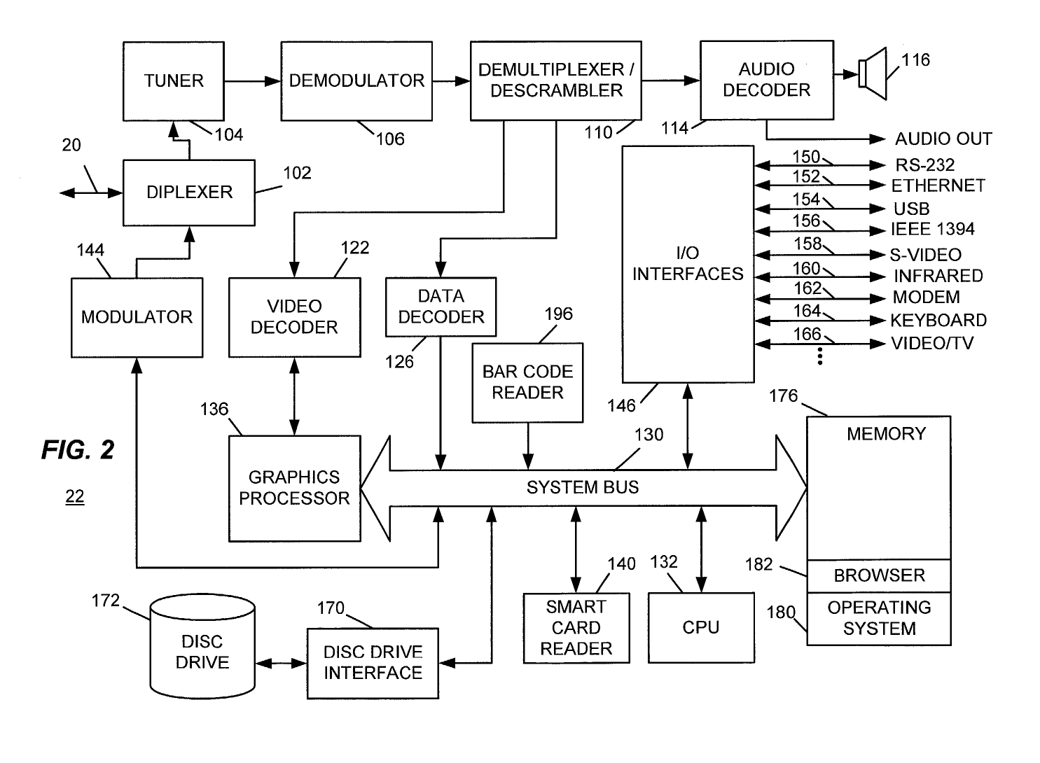

Referring now to FIG. 2, a typical system configuration for a digital set-top box 22 is illustrated. In this exemplary set-top box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-link™) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bidirectional communication via the DOCSIS cable modem with the STB 22 being identified by a unique IP address. The DOCSIS specification is publically available.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD R/W drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system 180 such as, for example, Sony Corporation's Aperios™ real time operating system is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 22 usually operates using browser software 182 in active memory or may permanently reside in ROM, EEPROM or Flash memory, for example. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window - often occupying the entire area of screen 26).

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside (e.g., browsing, email, EPG, Video On Demand (VOD), rich multimedia applications, pay per view, etc.). The current invention can be utilized with any suitable set-top box software and hardware architecture.

With the enhanced intelligence of digital set-top boxes such as that depicted in FIG. 2, the set-top box in cooperation with service provider 10 operating as a Multi-Service Operator (MSO) can be used as a home management tool to secure price quotes for products and services and obtain desired relevant information. This can be done advantageously through the service provider 10 since the service provider 10 is able to obtain substantial knowledge about the subscriber to help isolate needed information, products and services. For example, since the service provider operates in a relatively small geographic region, it can readily associate the subscriber with vendors within the subscribers area that can submit quotes to provide products and services needed by the subscriber. In this manner, the user can use the STB as a communication tool to have local vendors bid on services and products desired by the subscriber. (The terms “bid” and “quote” as used herein are as commonly defined in the dictionary to refer to a vendor proposing a price to supply goods and services.) In accordance with certain embodiments of the present invention, a bar code reader 196, or other product identification reader, is used to read product identifiers such as bar codes from products in order to register those products with venders and service providers.

With reference back to FIG. 1, in order to facilitate use of the set-top box 22 as a home management tool, the service provider 10 may include a quote/advertisement server 84 with an associated quote/advertisement database 88. This database functions to contain data regarding vendors within a particular geographic area and their capabilities to provide services to subscribers. For example, the database can categorize services or products provided according to categories in a manner similar to those used in the Yellow Pages™, enabliing the subscriber to search for services using such categories and enabling to service provider 10 so solicit quotes on behalf of the subscriber to an appropriate category of service provider.

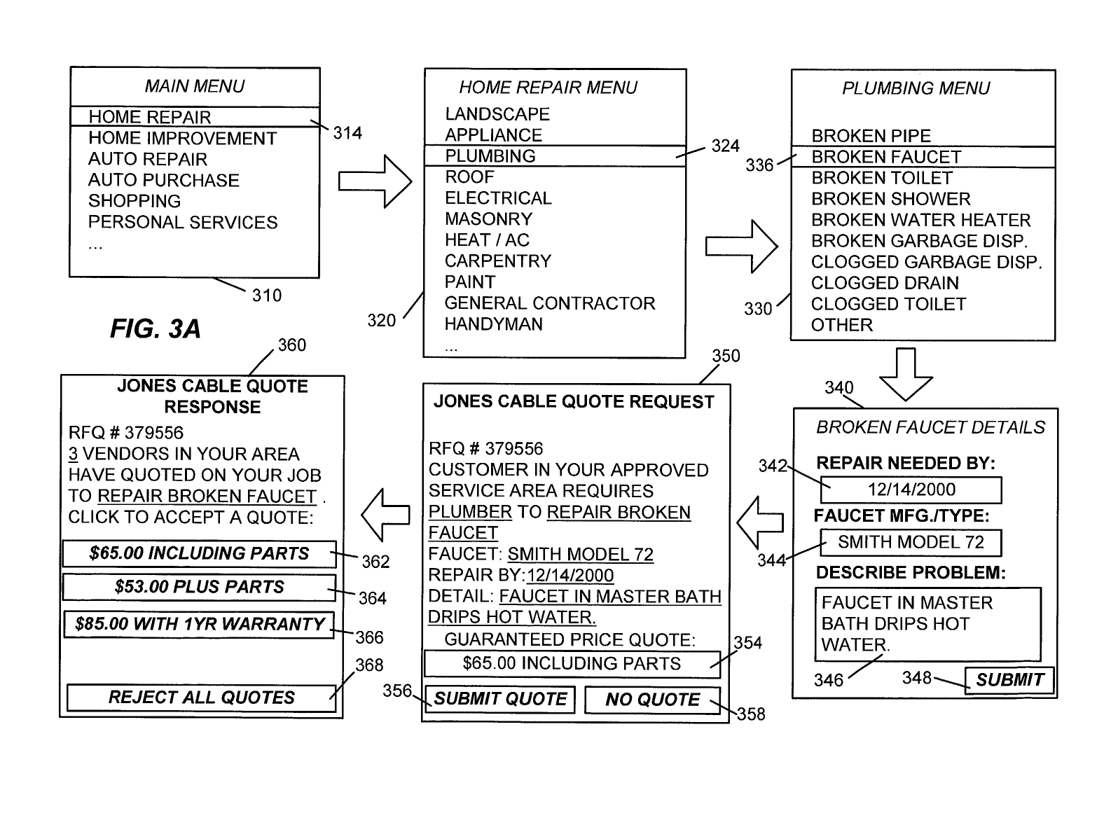

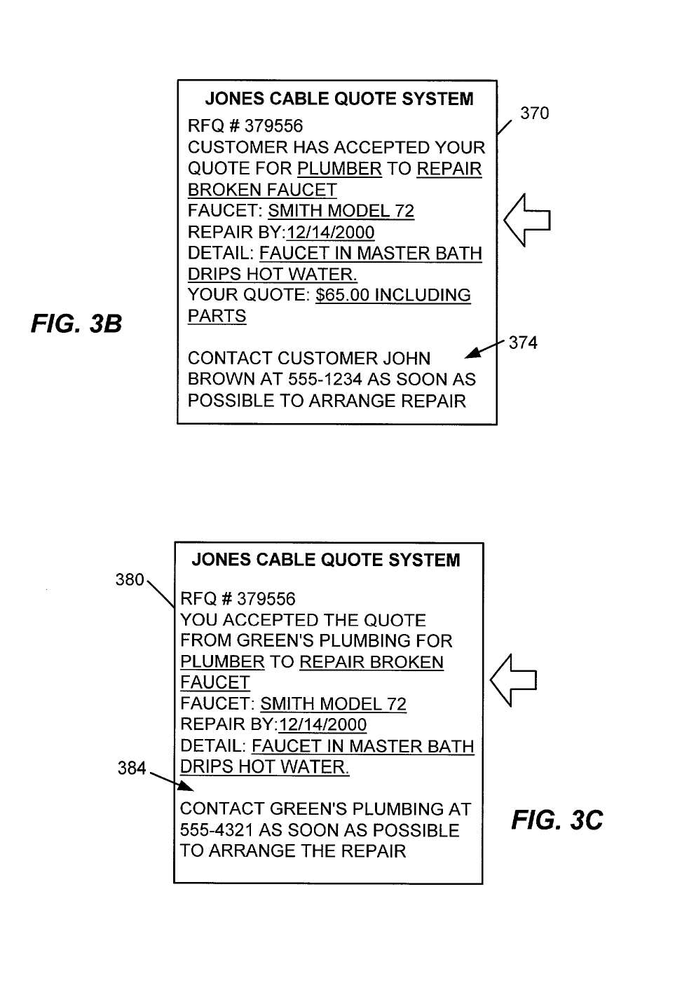

In one embodiment of the present invention, the subscriber can utilize a menu system called up from his or her set-top box 22 and displayed on display 26 to seek out services using a hierarchical menu system. With reference to FIG. 3A, viewed in conjunction with FIG. 3B and FIG. 3C (i.e., FIG. 3), an exemplary menu system permitting the user to obtain varying services is illustrated. A main menu 310 includes a plurality of selections of broad categories of services provided by service provider 10. In the example illustrated, various repairs, services, improvements and purchases are available to the user. In the example illustrated the user might select home repair menu selection 314 in order to obtain home repair services. This could be accomplished, of course, by use of remote controller 36 navigating through the menu, highlighting appropriate selections and then making the selections by pressing an enter button (on a screen or on remote controller 36) in a more or less conventional manner of navigating menus using a remote controller. In other embodiments, a keyboard and mouse or other input devices could also be used.

Upon entering the selection, the user is taken to a home repair menu 320 which divides the type of repair into a number of general categories such as appliance repair, roof repair, carpentry, plumbing, etc. In this instance the user may select the plumbing selection 324 in order to obtain a plumbing related repair. At this point, the user is passed to a plumbing menu 330 that breaks plumbing repairs into a number of categories including various broken components, clogs, etc. In addition, at this point, the user could elect to simply see a list of plumbers registered with the service provider 10 by making an appropriate selection. This process will be illustrated in greater detail later.

In the example shown in FIG. 3, the subscriber selects broken faucet menu item 336 which leads to a data entry form 340 that permits the user to provide various details about the service needed. In this case, the subscriber is able to indicate when the repair is needed by entering information in a data entry form block 342, provide details of the type of device needing repair at 344 and describing in freeform the details of the repair needed at 346. This, of course, can be implemented using HTML pages in a known manner. When the user completes entry of information into form 340, the form is submitted by selection of submit button 348.

Upon submission of details to the service provider 10, the service provider 10 assigns a quote identifier (in this case RFQ #379556) and assembles the data submitted by the subscriber into a quote request message 350 (Request For Quote, RFQ) that can be sent via E-mail through the Internet or through the service providers own system to vendors which have appropriately registered with the service provider. In this case, vendors who have registered with the service provider 10 as “plumbers” would receive RFQ's relating to plumbing from the service provider.

Message 350 includes the details provided by the subscriber, but in the preferred embodiment it does not identify the subscriber. In this embodiment the subscriber is only identified by the RFQ number. Thus, the vendor has no idea who is requesting the work and must submit a quote (i.e., bid on the job) based solely on the information provided by the subscriber and with the knowledge that other plumbers will be bidding on the same RFQ. To do so, the quote request may be implemented as an HTML page also permitting the vendor to fill in a quote at one or more form entry blocks 354 and submit the quote by selecting the submit quote button 356. Or, the vendor may elect not to bid on the job in which case the message can either be disregarded or the no quote button 358 can be selected.

When the vendor elects to submit a quote, the quote is retained for an appropriate period of time and then assembled with other quotes for a particular job. It is then transmitted back to the subscriber, for example, as message 360 which, again, can be transmitted by E-mail, retrieved by the subscriber using set-top box 22 and displayed on display 26. In an alternate embodiment, each individual quote can be sent to the subscriber as it is received. In the present example, three quotes have been forwarded to the subscriber and those are represented by selections 362, 364 and 366. By selecting any of the selections 362, 364 or 366, the user can accept one of the quotes or, alternatively, the user can reject all quotes by pressing selection 368. In the example illustrated, when a selection is made of quote 362, a message is transmitted back to the service provider from set-top box 22 so that service provider 10 knows that subscriber has accepted a quote. Service provider 10 then notifies the vendor with a message such as 370 so that the vendor knows his quote has been accepted. At this point, the service provider 10 can identify the customer to the vendor as illustrated in 374 so that the vendor can proceed with directly contacting the subscriber to arrange the service. In a similar manner, a message 380 is transmitted to the subscriber to inform the subscriber of whose quote was accepted. This information is provided in area 384 so that the subscriber knows who to contact to arrange for service.

In an alternative embodiment, the subscriber can be provided with information about who is quoting on the job along with the quote so that the message 380 may be redundant or unnecessary. In accordance with the process just described in conjunction with an exemplary menu system, several business models can be devised for the service provider 10 to capitalize on this system. In one embodiment, a subscription fee can be charged to the subscriber to permit the subscriber to use the quote service. In another business model, the subscriber can be charged a fee for each use of the quote system. In another model, a subscription fee can be charged to vendors who wish to receive requests for quotes. In yet another model, vendors can be charged on a per use basis to receive the requests for quotes. In yet another business model, a fee can be charged to the vendor who actually receives acceptance of his quote. In yet another business model, a subscriber can be charged a fee whenever a quote submitted by the system is accepted. Also, various combinations of the above business models can be implemented to facilitate a profitable enterprise.

FIG. 4 illustrates a message flow diagram 400 for the process just described. At 402 an RFQ is submitted to the service provider 10 (MSO). The service provider 10 in turn forwards the RFQ at 404 and 408 to the two vendors illustrated. Although illustrated as two messages, it could well be a single broadcast message broadcast to a number of addresses. Vendors 1 and 2, may then, if they desire, submit a quote back to the service provider 10 illustrated as 412 and 414. Those quotes are in turn relayed to the service provider as quotes 416 and 418 to the subscriber. If the subscriber accepts a quote at 422 vendor 1 and vendor 2 are notified at 424 and 428 and the subscriber is notified at 432 of the identity of the winning vendor. In the example illustrated, vendor I is awarded the job and therefor notification message 428 includes the identity of the subscriber making the request for quote. Message 424 to vendor 2, however, only indicates to vendor 2 that he has not been awarded the job. Once the subscriber and vendor 1 are identified to one another, direct communication between the two can ensue at 436 to facilitate making arrangements for the service.

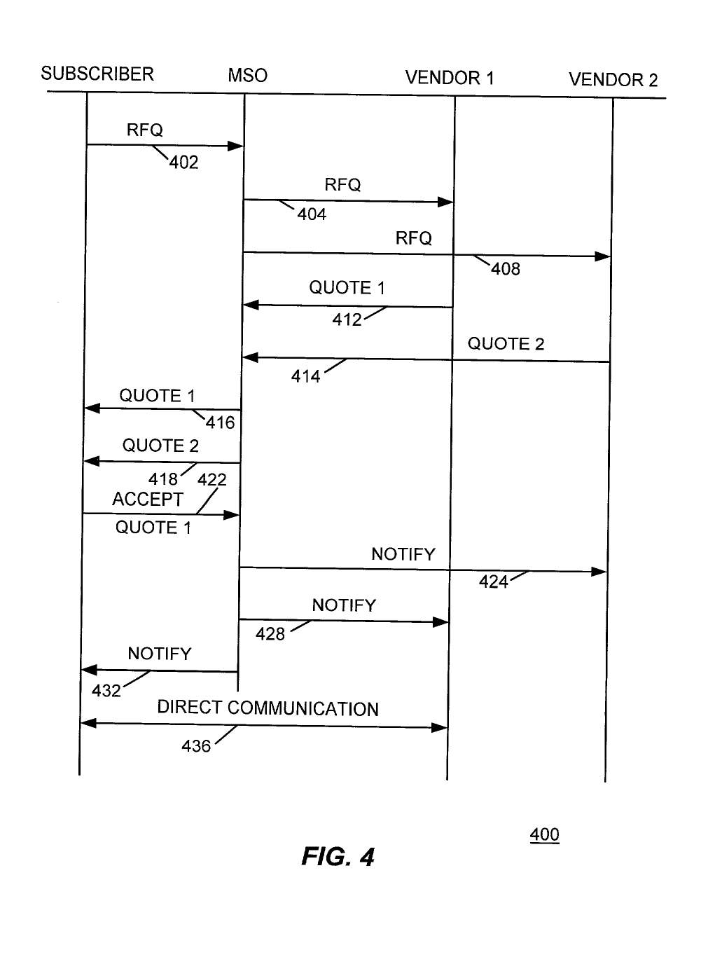

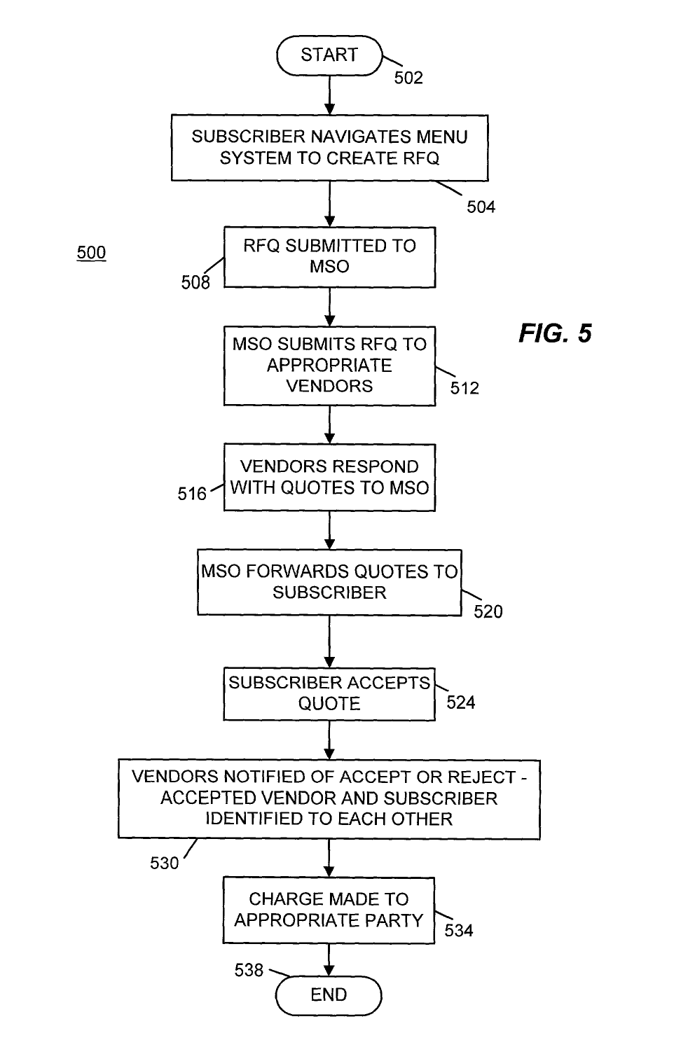

This process is further illustrated by the flow chart of FIG. 5 as process 500. The process starts at 502 after which the subscriber navigates through a menu system to create the request for quote at 504. At 508 the request for quote is submitted to the service provider. At 512, the service provider submits the RFQ to appropriate vendors that match the criteria established by the subscriber while navigating the menu system. At 516 vendors respond with quotes to the service provider and at 520 the service provider forwards the quotes to the subscriber. The subscriber can accept a quote at 524 and the vendors are notified of having been accepted or rejected at 530. In addition, the accepted vendor and subscriber are identified to each other.

As previously described, the subscriber may already know the identity of the vendor he has selected. The subscriber and vendor can then make arrangements for the service. At 534 (which may appear at other times in the sequence) an appropriate charge can be made to the appropriate party or parties in accordance with the business model used to establish the quote system of the present invention. The process ends at 538. Those skilled in the art will understand that many variations are possible within the bounds of the present invention. The menu system used to generate the quote can be more or less hierarchical then described and may provide other paths for the user to take without departing from the present invention. Moreover, the flow chart of FIG. 5 illustrates the basic process but many additional details will be added to implement the process but which are not shown in detail herein in order to avoid obscuring the invention.

In accordance with another embodiment of the present invention, the menu system can be utilized to register purchases (or register products already owned) with local vendors who may wish to provide special discounts, services or information. In this example, again, main menu 310 is called up by the user using remote controller 36 or any other suitable mechanism. In this case, the subscriber selects menu selection 614 in order to register a purchase. This selection takes the user to menu 620 where the type of purchase can be categorized into a number of categories—for example, appliances, automobiles, musical instruments and the like. In addition, by registering various products, the user can obtain advice for using those products. An example of this would be to enter a plurality of grocery items and request help in planning a menu around the grocery items at hand.

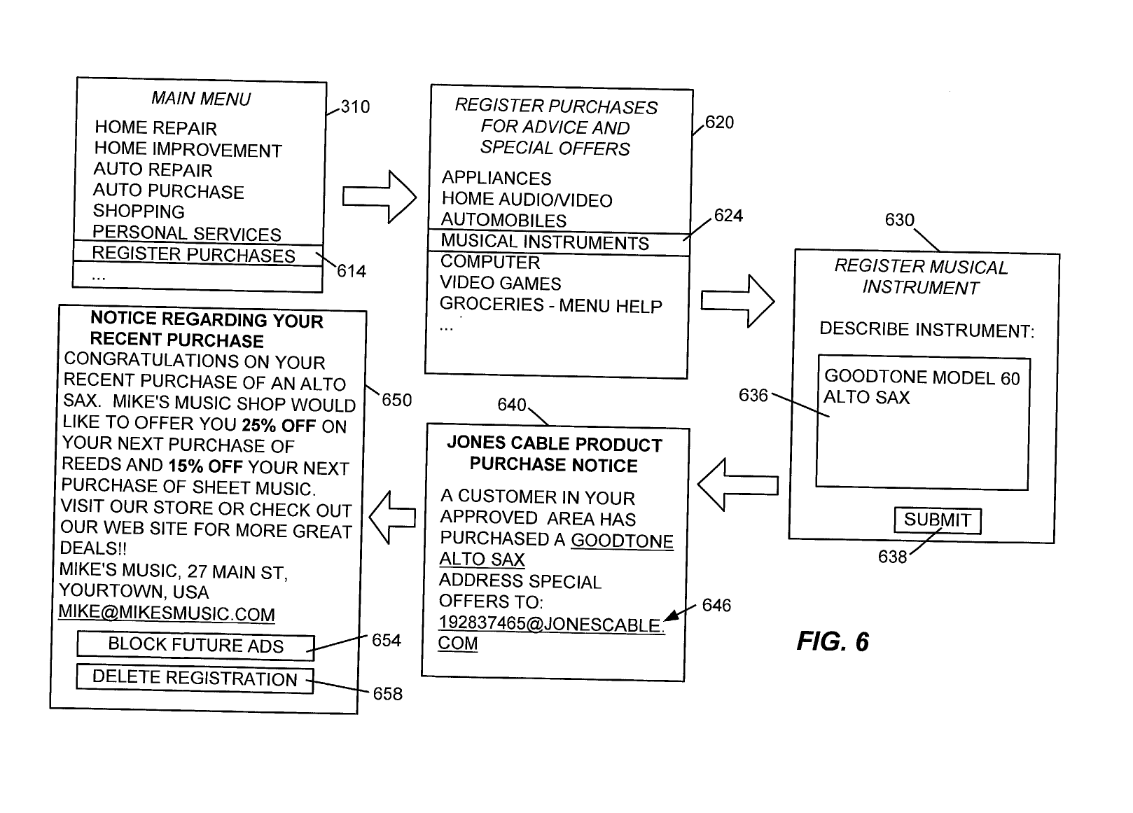

In the example of FIG. 6, the subscriber selects musical instruments 624 from menu 620, which takes the user to a registration form 630 in which the user is permitted to describe the item purchased in a data entry form box 636, or may scan a bar code (or other product identifier) associated with the product using bar code reader (or other product identification reader) 196. The user then submits the registration form using button 638. Upon submitting the registration form, the form is transmitted to the service provider 10 who queries a database stored in database 88 for advertisers that wish to communicate with owners of this category of product. As a result of the purchase, various vendors (in the case probably music stores) can be notified using message 640 of the purchase and the vendor can be provided with an alias E-mail address shown as 646 in which to direct advertisements or special offers. By providing the user with an alias, the users identity can be disguised from vendors so that the user in cooperation with the service provider 10 can control receipt of offers that are not desired.

A vendor receiving the notice 640 may thus generate offers such as that shown as 650 that can be mailed to the alias E-mail address 646 offering special discounts, information or other communications. When the user receives the message, it can be formatted as an HTML page with the user given button 654 and 658 to permit the user to block future ads from this particular vendor or delete the registration altogether respectively if desired. In this manner, the user can control the receipt of junk mail or the source of junk mail which he does not wish to receive. In other embodiments, a user's actual email address can be used without the anonymity features of the above embodiment.

Again, several business models present themselves for this service. In one such model, the vendor can be charged for submitting vendor registrations to match with user registrations. In another business model a fee can be charged to the vendors for forwarding their submissions. In yet another model, a subscriber can be charged a fee for submitting product registration data. In yet another model, a subscription fee can be charged to the subscriber to allow submission of multiple product registrations. Of course, combinations of the above models can be utilized to formulate additional business models.

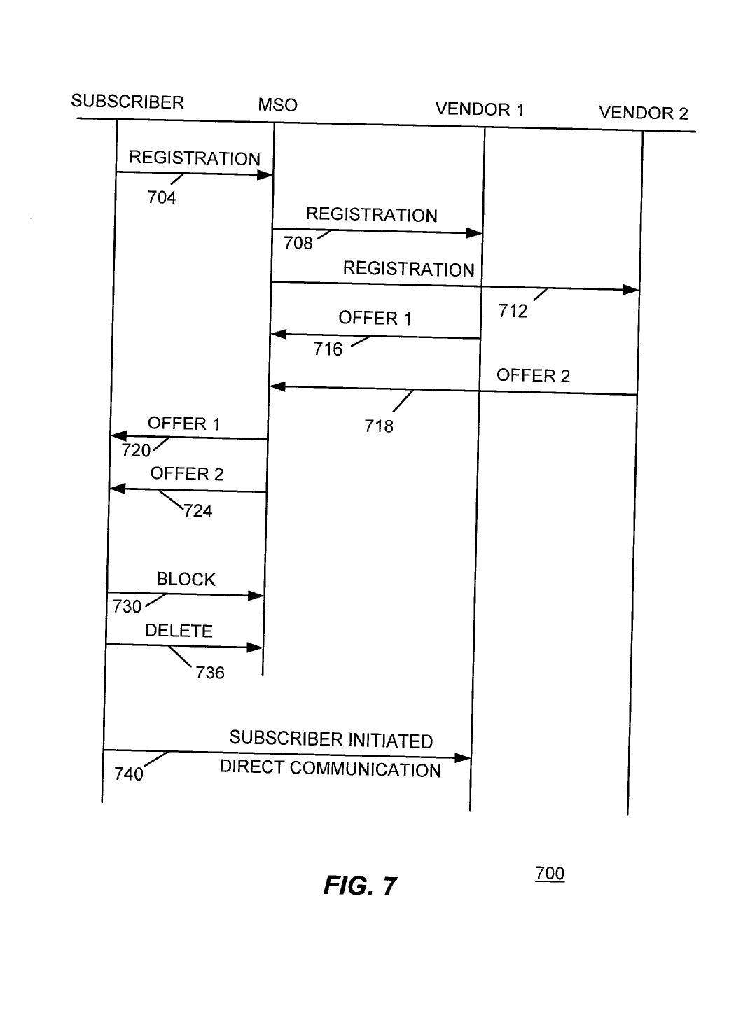

FIG. 7 shows a message flow diagram corresponding with an example of the product registration embodiment just described. In this example, a registration message is sent from the subscriber to the service provider at 704. That registration is in turn forwarded to vendor 1 and vendor 2 as registration 708 and 712. Vendor 1 and vendor 2 can then make offers, offer 1 and offer 2, by messages 716 and 718 directed to the alias through the service provider 10. Those offers are then forwarded as messages 720 and 724 to the subscriber.

In the event the subscriber wishes to block future messages or delete future messages, those elections are represented by messages 730 and 736 respectively. Any communication between the subscriber and vendor can be initiated if desired by the subscriber at 740. However, since the vendor only knows the subscriber by alias, any contact with the subscriber is subject to filtering by the service provider 10.

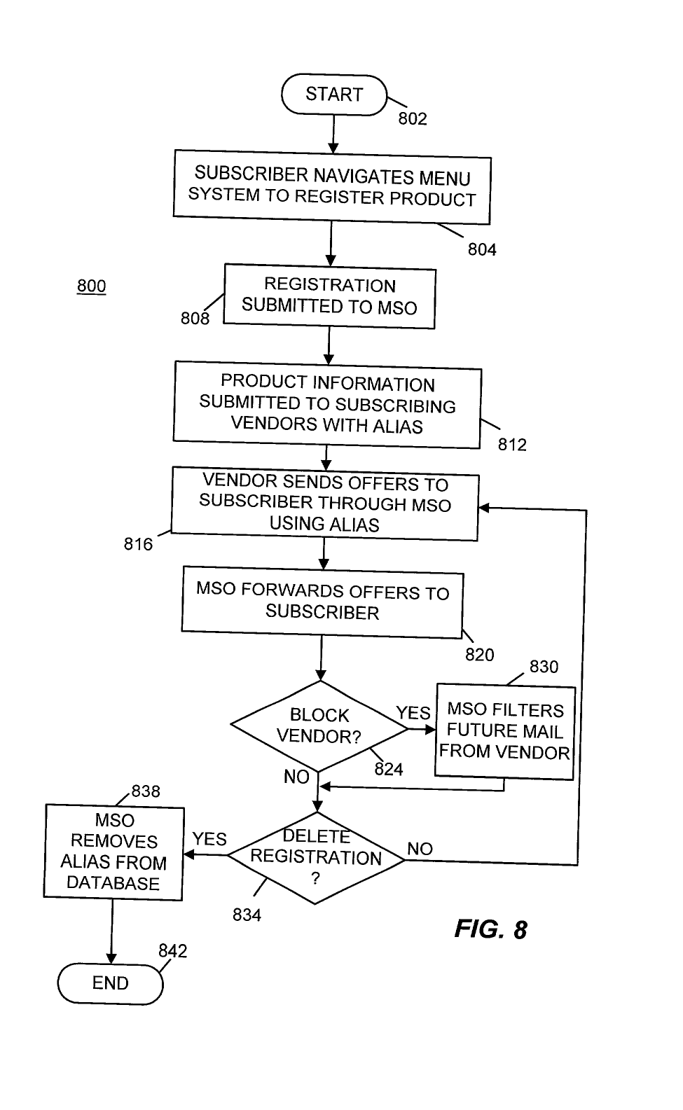

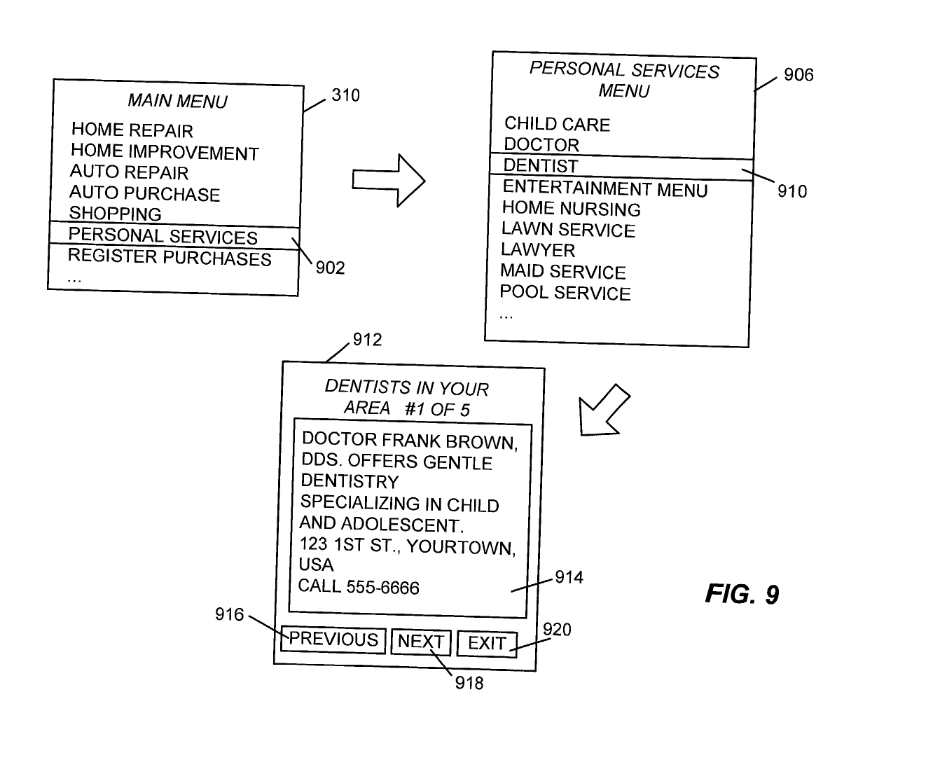

The flow chart 800 of FIG. 8 describes the product registration process starting at 802. At 804 the subscriber navigates a menu system to register the product, possibly using bar code reader 196 to simplify entry of information about the product (or bypassing most of the menu system entirely). The registration is then submitted to the service provider at 808. Product information is then submitted to subscribing vendors with an alias used to represent the subscriber at 812. The vendor can then send offers to the subscriber through the service provider using the alias at 816. The service provider forwards offers to the subscriber subject to any filtering required by the subscriber at 820. If the subscriber chooses to block a vendor at 824, then the service provider filters future mail from that vendor at 830. The vendor then is able to continue sending offers periodically as it sees appropriate until the registration is deleted at 834 or the vendor is blocked at 824. If the registration is deleted at 834, the service provider removes the alias from his database at 838 and may notify the vendors accordingly. The process ends at 842. Again, those skilled in the art will recognize that many variations of the current process are possible without departing from the present invention.

A directory type service can also be readily integrated into the present invention as briefly described previously in connection with the example where the user might simply desire a list of available vendors (e.g., plumbers). In accordance with this embodiment, a suitable selection such as personal services selection 902 can be made from menu 310 which leads to menu 906 where the user can select from a plurality of categories of services such as dentist 910. Selection 910 leads to a query of the database 88 at the service provider 10 to identify dentists within close geographic proximity of the subscriber. Vendors, who have subscribed to this service, in much the same manner of a Yellow Pages™ type subscription or advertisement, can provide submissions of advertisements to be forwarded to those subscribers who make an appropriate query of the database. In this example, five dentists are identified in window 912 with a first dentist identified by an advertisement submission 914. The user can then navigate through the five identified vendors using previous and next buttons 916 and 918 respectively. When completed, the subscriber can exit using button 920 or other suitable control available in the remote controller.

Several business models also present themselves for such an information service. In one such model, a fee can be charged to vendors for submitting their submissions. In another model, fees can be charged to vendors when their submissions are forwarded to subscribers. In another model, a fee can be charged to pay subscriber for submitting a request for information. In yet a further model, a subscription fee can be charged to a subscriber to allow submission of requests for information. Of course, combinations of these models can also be implemented without departing from the present invention.

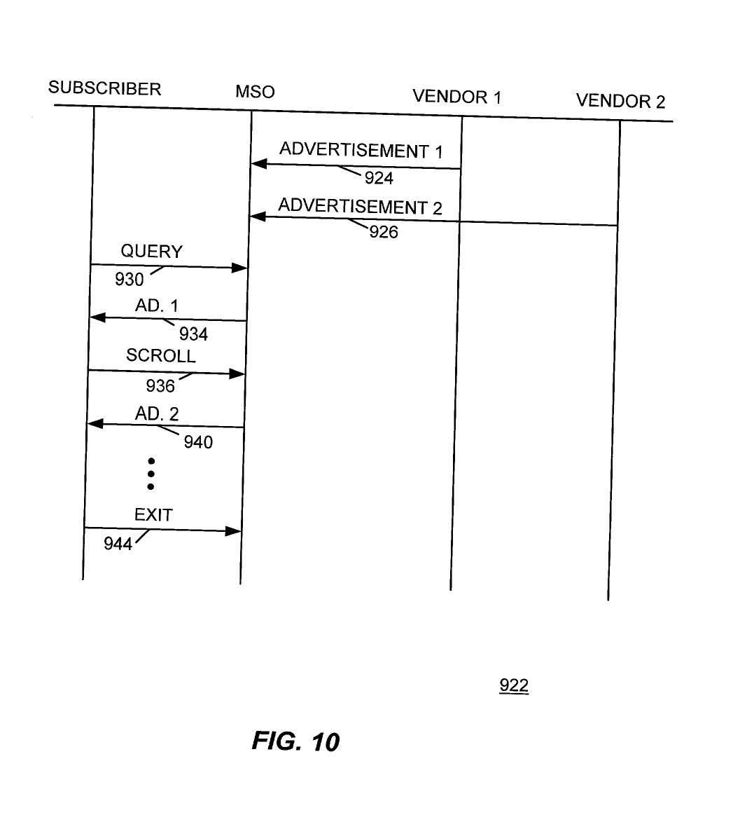

Referring now to FIG. 10, the information request process of the present embodiment is illustrated in the form of a message flow diagram 922. In this exemplary message flow, vendor 1 and vendor 2 can submit advertisements I and 2 (924 and 926 respectively) to the service provider 10. The subscriber submits a query 930 to the service provider 10 who, as a result of a database search, returns advertisement 1 at 934. By scrolling at 936, the subscriber can also vide advertisement 2 at 940 and so forth until the he or she chooses to exit at 944.

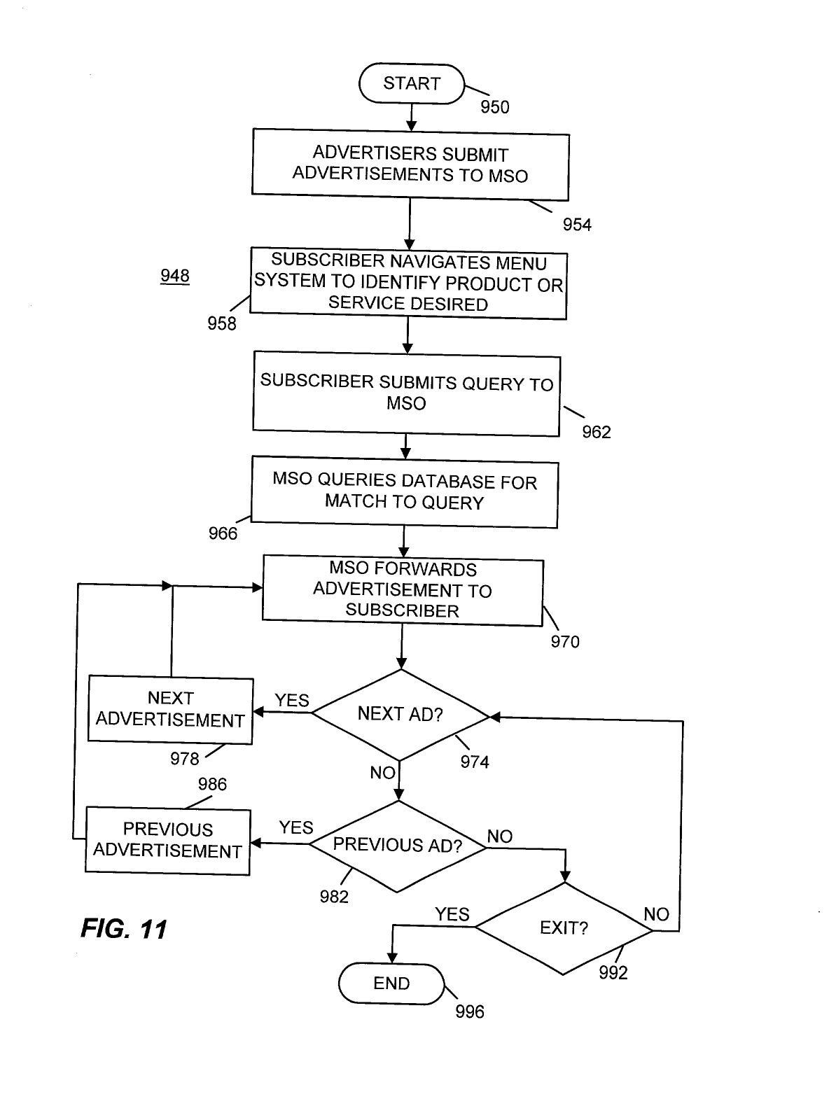

This process is further illustrated in connection with the flow chart of process 948 of FIG. 11 starting at 950. At 954, advertisers submit advertisements to the service provider 10 which are cataloged and indexed appropriately in the service provider 10's database 88. The subscriber can navigate a menu system to identify products and services desired at 958. The subscriber then submits a query to the service provider at 962 and the service provider queries database 88 for matches to the appropriate vendors at 966. Matching advertisements are then forwarded to the subscriber at 970. When the user selects the next of a group of advertisements at 974, the next advertisement is incremented at 976 and again the service provider forwards the advertisement to the subscriber at 970. In a similar manner, the user can navigate to the previous advertisement at 982 and the previous advertisement is retrieved at 986 for forwarding to the subscriber at 970. This continues until the user chooses to exit at 992 and the process ends at 996. Of course, again, many variations of the present invention are possible without deviating from the invention.

Thus, the present invention provides a set-top box centric method for a subscriber to obtain information, quotes and register products to receive special offers and advertisements while simultaneously providing a service provider with another avenue for generating revenue and various vendors with an avenue for reaching their target market. Since the set-top box is a convenient communication device for such process and since the service provider is comparatively regional, appropriate services can be readily matched up to the subscriber's needs by appropriately correlating vendors with subscribers at the service provider 10.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form, and which can be stored in any suitable electronic storage medium. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A television set-top box, comprising:
a tuner for receiving signals representing television programming and delivering the signals representing television programming to a display interface;
a central processor;
a bar code reader, operatively coupled to the central processor, to read bar codes; and
program means, running on the central processor, for receiving bar code information from the bar code reader.

2. The apparatus according to claim 1, further comprising a communication device, operatively coupled to the central processor, suitable for sending and receiving data over a communication medium.

3. The apparatus according to claim 2, wherein the program means further communicates with the communication device to send information obtained from the bar code reader to a service provider.

4. The apparatus according to claim 3, wherein the communication device further receives data from the service provider associated with the bar code.

5. The apparatus according to claim 4, wherein the data received from the service provider comprises offers for products or services associated with the bar code.

6. The apparatus according to claim 4, wherein the data received from the service provider comprises uses for a product associated with the bar code.

7. A method of obtaining quotes, comprising:
at a set-top box, submitting a request for quote (RFQ) to a service provider;
at the service provider, resubmitting the RFQ to a plurality of vendors;
at the service provider, receiving a plurality of quotes from vendors; and
at the service provider, forwarding the quotes to the set-top box for communication to a subscriber.

8. The method according to claim 7, further comprising, at the set-top box sending a message to the service provider to accept a quote from one of the plurality of vendors.

9. The method according to claim 8, further comprising, at the service provider, notifying the one of the plurality of vendors of the acceptance of the quote and of the identity of the subscriber.

10. The method according to claim 7, wherein the submitting is carried out by navigating a hierarchical menu system to identify a product or service required, and submitting the RFQ from the menu system.

11. The method according to claim 10, wherein the menu system comprises selections for obtaining quotes, registering products and obtaining information.

12. The method according to claim 7, wherein the subscriber is identified to vendors at the time of submission of the RFQ only by an RFQ identifier.

13. The method according to claim 7, further comprising charging a subscription fee to the subscriber to permit submission of the RFQ.

14. The method according to claim 7, further comprising charging a per use fee to the subscriber to permit submission of the RFQ.

15. The method according to claim 7, further comprising charging a subscription fee to the vendors to receive the RFQ.

16. The method according to claim 7, further comprising charging a per use fee to the vendors to receive the RFQ.

17. The method according to claim 8, further comprising charging a fee to the vendor receiving the acceptance.

18. The method according to claim 8, further comprising charging a fee to the subscriber as a result of receiving the acceptance.

19. A method of registering a product, comprising:
at a set-top box, submitting product registration data to a service provider;
at the service provider, entering the product registration data into a database,
at the service provider, matching the product registration data to a plurality of vendor registrations submitted by a plurality of vendors;
at the service provider, sending the product registration data to a plurality of matching vendors;
at the service provider, receiving a plurality submissions from the plurality of matching vendors; and
forwarding the submissions to the set-top box for communication to a subscriber.

20. The method according to claim 19, wherein the subscriber is identified to the matching vendors only by an alias.

21. The method according to claim 19, further comprising filtering advertisements out for vendors selected by the subscriber.

22. The method according to claim 19, further comprising charging a fee to the vendors for submitting vendor registrations.

23. The method according to claim 19, further comprising charging a fee to the vendors for forwarding the submissions.

24. The method according to claim 19, further comprising charging a fee to the subscriber for submitting product registration data.

25. The method according to claim 19, further comprising charging a subscription fee to the subscriber to allow submission of product registration data.

26. The method according to claim 19, wherein the submitting of the product registration is carried out by navigating a hierarchical menu system to identify a type of product to be registered, and entering product detail.

27. The method according to claim 26, wherein the product detail is entered by scanning a product code with a bar code reader associated with the set-top box.

28. The method according to claim 19, wherein the submitting of the product registration is carried out by navigating a hierarchical menu system and entering product detail by scanning a product code with a bar code reader associated with the set-top box.

29. A method of obtaining information, comprising:
at a set-top box, submitting a request for information to a service provider;
at the service provider, receiving the request for information and matching the request for information with a plurality of vendor submissions,
at the service provider, sending the plurality of vendor submissions to the set-top box for communication to a subscriber.

30. The method according to claim 29, further comprising charging a fee to the vendors for submitting vendor submissions.

31. The method according to claim 29, further comprising charging a fee to the vendors for sending the submissions.

32. The method according to claim 29, further comprising charging a fee to the subscriber for submitting a request for information.

33. The method according to claim 29, further comprising charging a subscription fee to the subscriber to allow submission of requests for information.

34. The method according to claim 29, wherein the submitting of request for information is carried out by navigating a hierarchical menu system to identify information desired.

35. A television set-top box, comprising:
a tuner for receiving signals representing television programming and delivering the signals representing television programming to a display interface;
a central processor;
a product identification reader, operatively coupled to the central processor, to read a product identifier; and
program means, running on the central processor, for receiving information from the product identification reader.

36. The apparatus according to claim 35, further comprising a communication device, operatively coupled to the central processor, suitable for sending and receiving data over a communication medium.

37. The apparatus according to claim 36, wherein the program means further communicates with the communication device to send information obtained from the product identification reader to a service provider.

38. The apparatus according to claim 37, wherein the communication device further receives data from the service provider associated with the product identifier.

39. The apparatus according to claim 38, wherein the data received from the service provider comprises offers for products or services associated with the product identifier.

40. The apparatus according to claim 38, wherein the data received from the service provider comprises uses for a product associated with the product identifier.

41. The apparatus according to claim 35, wherein the product identification reader comprises a bar code reader, and wherein the product identifier comprises a bar code.
